(19) United States
(12) Patent Application Publication
(10) Pub. No.: US 2015/0086313 A1
(43) Pub. Date: Mar. 26, 2015

(54) RETRACTABLE PLATFORM FOR VEHICLES

(71) Applicant: Richard Perez, Hialeah, FL (US)

(72) Inventor: Richard Perez, Hialeah, FL (US)

(21) Appl. No.: 14/033,595

(22) Filed: Sep. 23, 2013

(51) Int. Cl. B60P 1/43

(52) U.S. Cl. CPC B60P 1/433
USPC 414/537

(57) ABSTRACT

A retractable platform mechanism for a vehicle having a cargo area adjacent to its rear bumper 30, which includes a cut out 32 that permits a platform assembly 40 to pass therethrough and being slidably mounted to a supporting rail assembly 20 and movable between two extreme positions. A ramp assembly is housed within platform assembly 40 is selectively and transversally deployed. Optionally, a mechanism for moving assembly 40 is provided for moving that can be manually actuated with a crank or with an electronic motor. Extension assembly 90 can be optionally mounted to extend the cargo capacity.

### BACKGROUND OF THE INVENTION

1. Field of the Invention

The present invention relates to a retractable platform for sport utility vehicles (SUVs) and, more particularly, to such platform that is versatile and permits a user to easily transport different types of loads.

2. Description of the Related Art

Several designs for retractable platforms have been designed in the past. None of them, however, include a retractable platform that protrudes through the rear bumper of a vehicle.

Applicant believes that the closest reference corresponds to U.S. patent application publication No. US2010/0045012A entitled Vehicle Lift filed on behalf of Brad Christian, published on Feb. 25, 2010 for a vehicle lift. However, it differs from the present invention because it does not show a platform that is completely retractable through the rear bumper and selectively stored under the cargo area of an SUV. Nor does it disclose a retractable ramp assembly or the other features of the invention relating to its versatility and capability of extending itself.

Other documents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a retractable platform that can be selectively stored within a SUV and below its cargo area.

It is another object of this invention to provide such a platform that can be readily deployed by moving it out through a cooperating cut-out the SUV's rear bumper.

It is still another object of the present invention to provide a platform that is versatile enough to carry a variety of different loads.

Another object of this invention is to provide a versatile platform that includes a retractable ramp.

It is yet another object of this invention to provide such a platform that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an isometric view of a vehicle V (in broken lines) provided with an embodiment 10 of the present invention inside vehicle V.

FIG. 1B shows different positions for the latches 46 shown in the previous figure.

FIG. 1C shows the platform illustrated in the previous figure with the bicycle latches raised to secure the bicycles (not shown) in place.

FIG. 1D shows the invention represented in the previous figures with ramp 60 removed to reduce weight.

FIG. 2 is an isometric bottom view of the platform 40 with the ramp assembly 60 being partially shown. In this figure, platform assembly 40 is shown moved out to its outermost position using motor 82.

FIG. 2A is a partial view of worm screw rod 84 and crank handle 85 to manually rotate the former instead of using motor 82 and driver unit 83 (not shown). When handle 85 is actuated, driver unit 83 does not rotate but rather allows screw rod 84 to advance relative thereto.

FIG. 3 similar to FIG. 2 except that motor 82 has been actuated to move (rotate) through drive unit 83 which causes worm screw 84 to advance and platform assembly 40, to move in the direction of the arrow.

FIG. 3A is an elevational view of a rear bumper 30 with cutout 32.

FIG. 4 is similar to FIGS. 2 and 3 and shows platform assembly 40 moved further towards the interior ends of structural members 22; 22a of rail assembly 20, rigidly mounted to vehicle V's chassis (not shown).

FIG. 5 is similar to the previous figures except that structural guiding channels 27; 27a of platform assembly 40 now house rail assembly 20 fully corresponding to the retracted position.

FIG. 6 is an isometric view of retractable platform mechanism 10 with extension assembly 90.

FIG. 6A is an elevational view of extension assembly 90 with bicycle B mounted thereon.

FIG. 7 represents an elevational view section of platform assembly 40 housing ramp assembly 60 therein.

FIG. 7A is a view similar to FIG. 7 with assembly 60 pulled out and coplanarly disposed with respect to platform assembly 40.

FIG. 7B is similar to the previous two views except that outer ramp portion 62 has been dropped to the ground.

FIG. 7C is similar to the previous three figures with outer ramp portion 62 extending at a substantially coplanar relationship with inner ramp portion 64, both being inclined.

FIG. 7D shows a partial cross section taken along line 7D-7D in FIG. 7.

FIG. 7E is an enlarged partial isometric view of assembly 40 wherein elongated bar is protruding past top wall 45 giving ramp section 64 (not shown) sufficient clearance to be pulled out.

### DETAILED DESCRIPTION OF THE EMBODIMENTS OF THE INVENTION

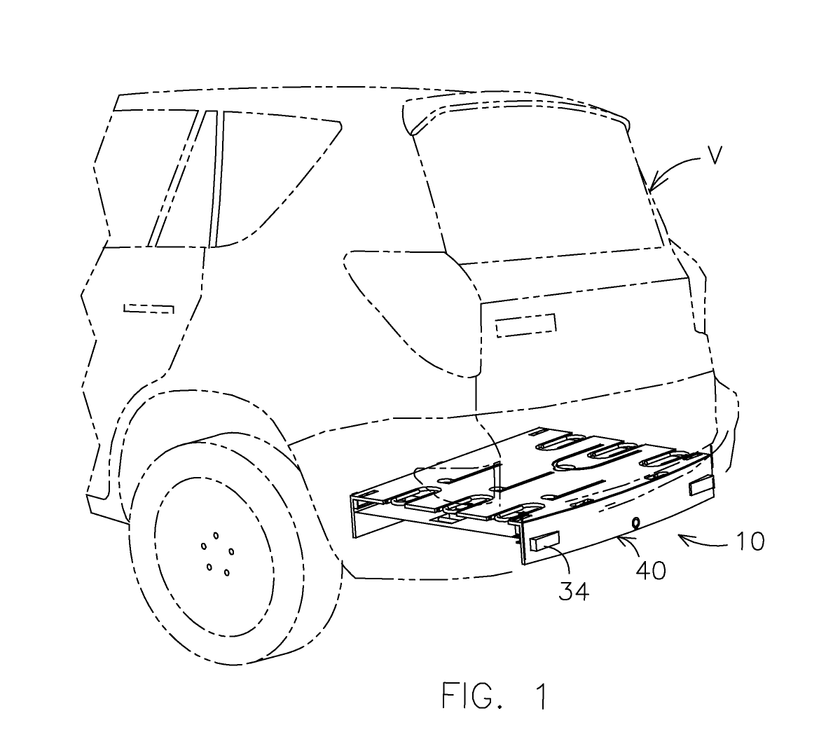

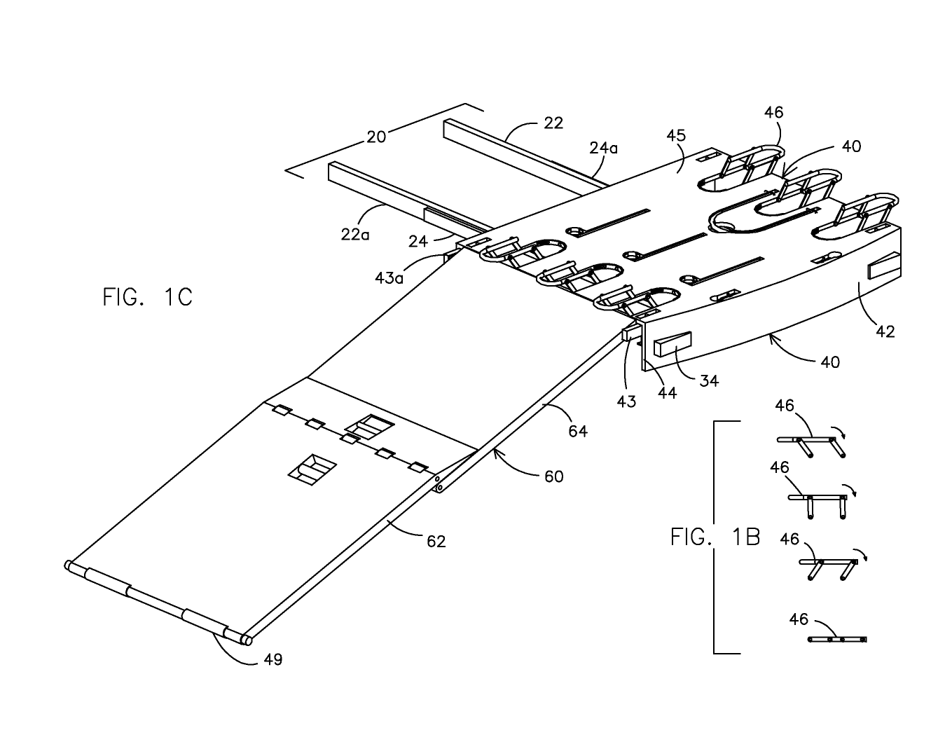

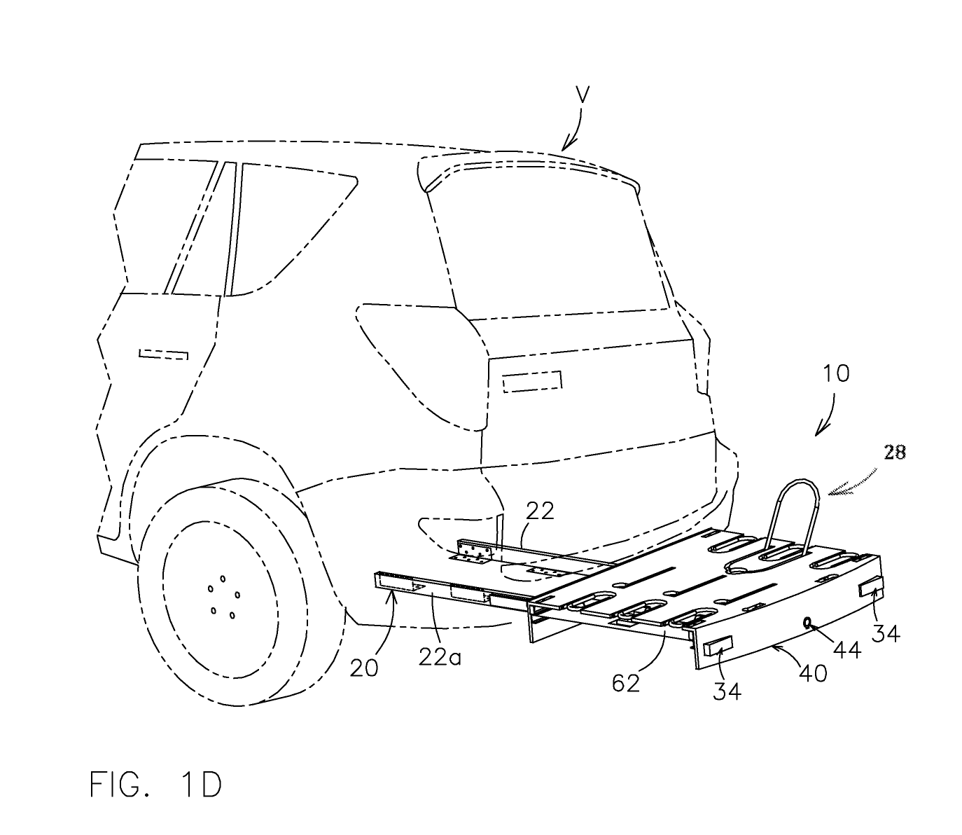

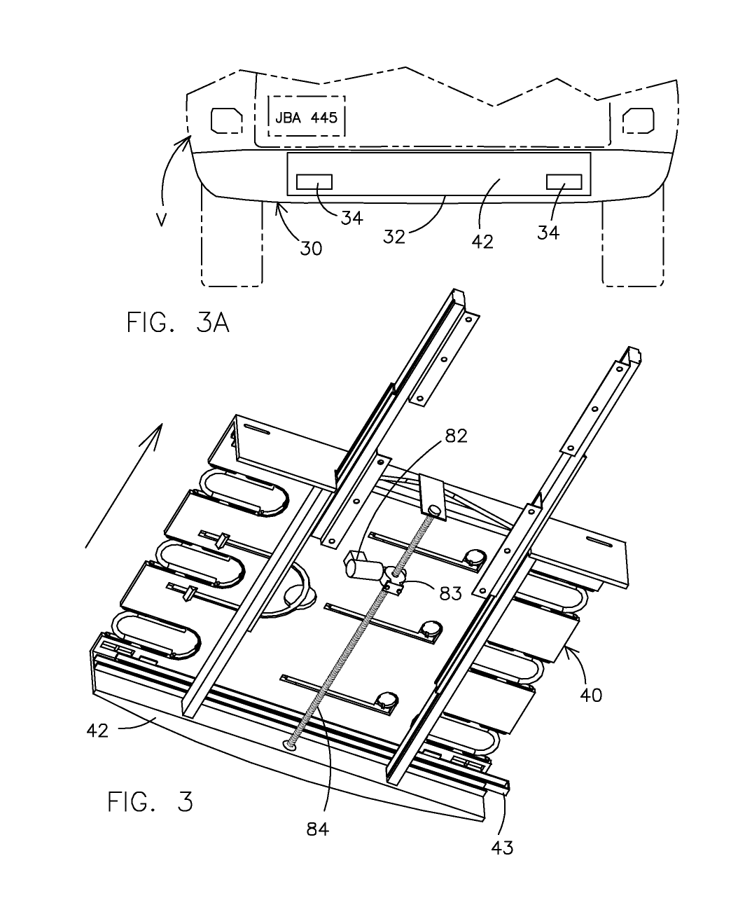

Referring now to the drawings, where the present invention is generally referred to with numeral 10, it can be observed that it basically includes a supporting rail assembly 20 inside vehicle V and support platform assembly 40, as best seen in FIGS. 1, and 1C. Vehicle V includes a rear bumper 30 with a cutout 32 having cooperative dimensions to permit assembly 40 to pass through it, as shown in FIG. 3A. Bumper end 42 is mounted to the other end of platform 40 (preferably to disguise cutout 32). Lighting assembly 34, compatible with vehicle V's electrical system, is provided to comply with safety regulations.

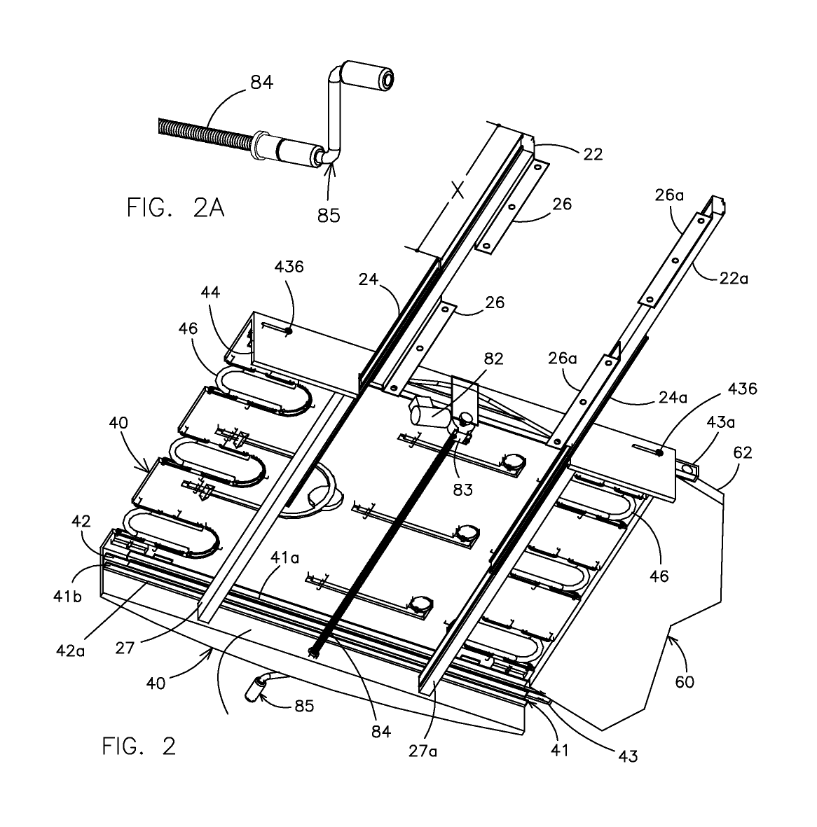

As best seen in FIG. 1C, supporting rail assembly 20 includes, in one of the embodiments, structural members 22 and 22a that are rigidly mounted to the chassis of vehicle V (not shown). Platform assembly 40 is also shown with sliding members 24 and 24a. Sliding members 24 and 24a travel longitudinally adjacent to members 22; 22a selectively causing platform assembly 40 to be deployed or retracted inside vehicle V. Brackets 26; 26a mount members 22; 22a to the chassis of vehicle V, as best seen in FIG. 2. Actuating assembly 80 imparts the necessary longitudinal movement to assembly 40. In the embodiment shown here assembly 40 can be manually moved with crank 85 if electrical motor 82 is not used or breaks down. Another embodiment would have no electrical or mechanical means and assembly 40 can be merely pulled manually and pushed inside vehicle V through cutout 32.

Platform assembly 40 includes bicycle latches 46 cooperatively positioned, as best seen in FIG. 1C. Latches 46 are collapsible to selectively permit a user to have a flat cargo area when needed. FIG. 1B shows the sequential movements of latches 46. Motorcycle latch 28 is shown in the collapsed position in FIG. 1C and it is preferably centrally located, as seen in FIG. 1C. In 1D motorcycle latch 28 is shown in the raised position.

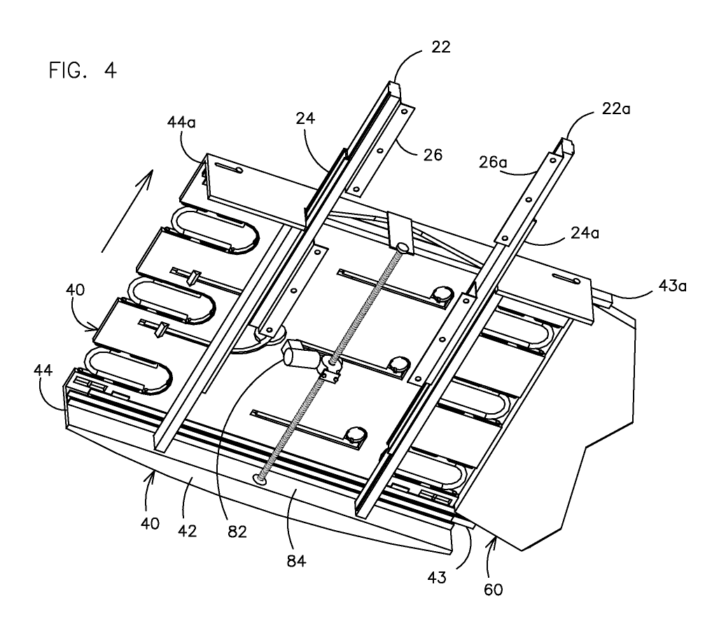

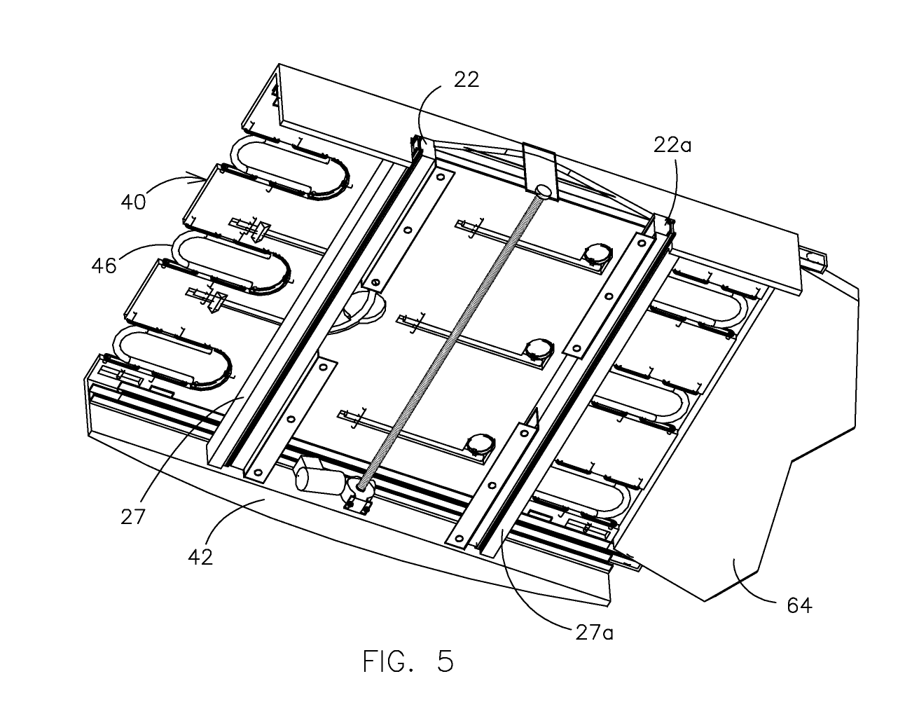

Platform 40 can be manually moved between the two extreme positions. However, actuating mechanisms of different types can be used to facilitate the task. As it can be seen from FIGS. 2 through 5, platform 40 can be moved with respect to rail assembly 20 with actuating mechanism 80 that may include motor 82, driver unit 83, and worm screw rod 84. One way for implementing actuating mechanism 80 includes the use of electric motor 82 and making rod 84 rigid (not allowed to rotate). Motor 82 is mounted to a fixed location relative to vehicle V′s chassis so that when it actuated it causes driver unit 83 to internally rotate causing worm screw rod 84 to advance thereby moving platform assembly 40 in either direction. Another way of implementing mechanism 80 is to use crank handle 85 allowing rod 84 to rotate and providing a fixed mating threaded element. In the present embodiment, driver unit 83 is used to provide this fixed mating threaded element when not used with motor 82. Driver unit 83 can be implemented with part number 4RK25GN-CWM, manufactured by Oriental Motor Co., LTD. When crank handle 85 is used, screw rod 84 is allowed to rotate and driver unit 83 is locked so that platform assembly 40 moves in and out when crank 85 is actuated.

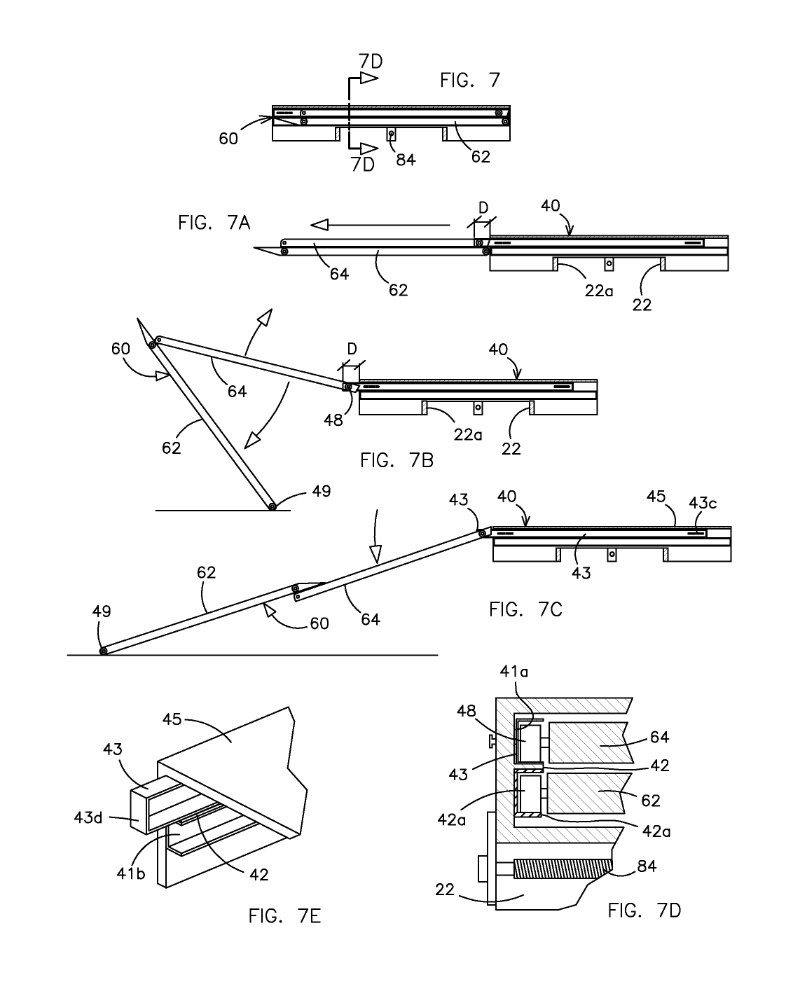

As seen in FIG. 1C, ramp assembly 60 can be deployed from inside assembly 40 to permit a user to load and unload bicycles and/or a motorcycle that are difficult to lift. Ramp assembly 60 includes, in the embodiment shown in FIG. 1C, outer and inner ramp sections 62; 64 that are hingedly mounted to each other. Sections 62; 64 can be folded and brought in abutting relationship with respect to each other. Their dimensions cooperate to be selectively housed within platform assembly 40, as best seen in FIGS. 7, 7A; 7B, and 7C. Guiding assembly 41 includes upper channel 41a to slidably receive ramp section 62 and lower channel 41b to receive ramp section 64, as seen in FIG. 2.

Elongated c-bars 43; 43a are slidably mounted within upper channels 41a as best seen in FIG. 7D. As seen in FIGS. 1C and 2, bars 43; 43a partially protrude outwardly to permit section 64 to pivot clearing top wall 45 of platform 40. See FIG. 7B showing the protrusion extending a distance “D” to clear platform 40. Stopper headed screw or pin 43b is removably mounted to a predetermined location that cooperates with slots 43c. Pins 43b coact with slots 43c to prevent c-bar 43 from sliding completely out of channel 41a. End walls 43d of bars 43; 43′, showing in FIG. 7E, coact with rollers 48; 48′, preventing bars 43; 43′ from sliding completely out.

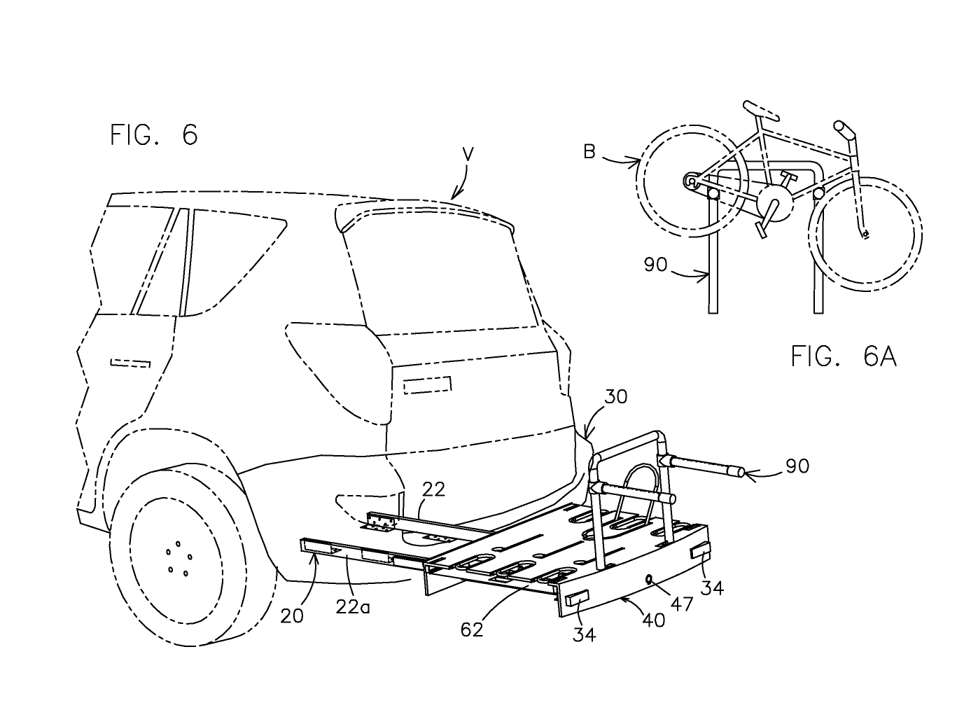

FIGS. 6 and 6A show extension assembly 90 that can be removably mounted to platform assembly 40 to increase the load that can be transported. Typically, extension assembly 90 can recline bicycle racks (not shown) and other accessories.

FIG. 7D is a partial cross section of assembly 40 wherein elongated bars 43; 43a house upper and lower channels 41a; 41b. These channels allow ramp sections 64; 62 to slide from one end of assembly 40 to the other. Ramp sections 64; 62 are attached to rollers 48; 49 which allow said ramp sections to slide in and out of assembly 40 with reduced friction. As seen in FIG. 7E, elongated bar 43 protrudes out of top wall 45 to allow ramp section 64 (not shown) to clear top wall 45.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A retractable platform mechanism for a vehicle including a rear cargo area comprising:
A) a bumper at rearmost end of said cargo area, said bumper mounted to said vehicle including a cutout having predetermined dimensions, at least two elongated supporting rail members rigidly mounted to said vehicle below said rear cargo area and each of said at least two rail members including a distal end;
B) a platform assembly having a substantially flat upper surface and a substantially rectangular shape being slidably supported by said rail members and said platform assembly having cooperative dimensions to pass through said cutout, being movable between two extreme positions, one of said positions being a fully retracted position inside said vehicle and the other position being a fully extended position protruding rearwardly out of said vehicle; and
C) a ramp assembly retractable within said platform assembly and moving transversally to be selectively deployed or retracted to facilitate the transportation of load to said upper surface.

2. The mechanism set forth in claim 1 wherein said platform includes at least one latch assembly pivotally mounted to said upper surface and movable between two extreme positions, one of said positions resting flush with said upper surface and the other position being raised to cooperatively engage the wheels of a bicycle.

3. The mechanism set forth in claim 2 further including:
D) an actuating assembly for moving said platform assembly between said two extreme positions.

4. The mechanism set forth in claim 3 wherein said actuating assembly includes a worm screw rod rotably and longitudinally mounted to said platform assembly and said rod being coupled with a cooperating threaded element rigidly mounted to a fixed location inside said vehicle so that when said rod is rotated said platform assembly moves between said two extreme positions.

5. The mechanism set forth in claim 4 wherein said rod includes a crank for manually rotating the former.

6. The mechanism set forth in claim 3 wherein said actuating assembly includes electric motor means for moving said platform assembly between said two extreme positions.

7. The mechanism set forth in claim 1 wherein said platform includes inner and outer ramp sections that are hingedly mounted to each other and said platform assembly further including internal upper and lower channels for receiving said inner and outer ramp sections, respectively, so that the latter can be selectively transversally deployed.
